(19) United States
(12) Patent Application Publication
(10) Pub. No.: US 2006/0190603 A1
(43) Pub. Date: Aug. 24, 2006

(54) Congestion controller and method for controlling congestion of network

(76) Inventors: Tomoya Anzai, Sagamihara (JP); Fumio Noda, Kodaira (JP); Yasuhiro Takahashi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/349,078

(22) Filed: Feb. 8, 2006

(30) Foreign Application Priority Data
Feb. 9, 2005 (JP) 2005-033058

(51) Int. Cl. G06F 15/173

(52) U.S. Cl. 709/226

(57) ABSTRACT

This invention efficiently restricts access to high-load web servers on an IP network, improves total throughput, and prevents web server and system stoppage and failures, while at the same time improving user service efficiency. After storing the association between IP addresses and host names into a memory, the congestion controller installed on the IP network controls a DNS server to acquire the IP address of a web server when a request is issued from a client to the web server, then if the web server of the IP address is judged to be congested, searches for another IP address of a non-congested web server associated with the same host name included in the memory-stored association, and forwards the client-issued request to the web server of the new IP address.

### CLAIMS OF PRIORITY

The present application claims prority from Japanese application serial no. JP2005-033058, filed on Feb. 9, 2005, the content of which is hereby incorporated by reference into this application.

### BACKGROUND OF THE INVENTION

The present invention relates to a congestion controller operating as a relay in communication between a client and a web server, and to a method of controlling congestion of a network. More particularly, the invention relates to a congestion controller, and method of controlling network congestion, suitable for use in the congestion control conducted when a web server is constructed of multiple web servers assigned to IP addresses using the DNS (Domain Name System) round robin.

Rapid proliferation of the Internet has made the provision of information and services therethrough take place as a familiar event. In addition, the proliferation of the Internet has enabled comfortable access from not only a PC (personal computer) terminal, but also a hand-held terminal, and access to web servers is increasing with a growing number of hand-held terminal users.

Under such a network environment, the concentration of access to a specific web server, e.g., to a web server that provides a service such as ticket reservations, securities transactions, or downloading favorite contents, occurs most often in the conventional scheme where users directly access web servers. As a result, the capacity of an associated communications line or the processing capability of the web server may not catch up with the access requests concentrated, and a delay in response or no response may occur. In the worst case, the web server itself may fail to operate.

In order to avoid these problems, the methods that employ load sharing based on the DNS round robin have been traditionally adopted at web server sites. As described in non-patent literature such as RFC1034 “DOMAIN NAMES—CONCEPTS AND FACILITIES” (http://www.rfc-editor.org/download.html), the DNS round robin is a method of distributing the web servers actually accessed, in which method, a plurality of IP addresses for a host name are registered in a DNS server assigned to solve host names, and when host name solution is actually requested from a client, different IP addresses are sequentially sent in response to the request. Using this method enables load sharing to be implemented by installing a plurality of web servers associated with the registered IP addresses.

Meanwhile, the site that provides an Internet environment employs a method of providing a relay apparatus, called a congestion controller, between a client and a web server, and controlling access to web servers. The congestion controller operates as a relay in client access to a web server. At the same time, the congestion controller monitors, for example, the quantity of simultaneous access to each web server, a response time, and a time-out error count, and if the preset threshold of either of these values is exceeded, judges the web server to be in a congested state. Subsequently, until the simultaneous-access count or the response time, for example, has decreased below the respective thresholds and release of the congestion has been confirmed by judgment, the congestion controller restricts access to that web server by responding to the client with a congestion message. Excessive concentration of access to the web server and a server failure can be prevented in this way.

The congestion controller usually manages web server access control for each host name. There is the problem, therefore, that during congestion control of the web servers that use the above-described DNS round robin, if one of plural web servers is judged to be congested, all requests to the corresponding host are restricted, regardless of the states of other web servers.

In contrast to the above, a method of controlling access to web servers for each IP address, not for each host name, by the congestion controller, has also been used. In this method, access to web servers of different IP addresses can be processed in normal way with the same host name, even when one of the web servers constructed using the DNS round robin is judged to be congested.

Another approach is by monitoring constantly or periodically at the client or DNS server site the load states of the plural web servers constructed using the DNS round robin, and sequentially returning, as a response to an address solution request, IP addresses lower in load or higher in access request response time. With this approach, even when congestion occurs in a web server, access to the web server that has been judged to be congested can be restricted by avoiding the IP address of the corresponding web server and responding with another IP address for the same host name. By way of example, US Published Application No. 2003/0055979 discloses a technique in which the resolver within a client makes a TCP connection request for all IP addresses that have been solved by a DNS server, and selects the IP address returned as the fastest response.

### BRIEF SUMMARY OF THE INVENTION

A problem occurs during IP address-based congestion control management by the congestion controller, as in the above conventional techniques. That is, if one of the plural web servers using the DNS round robin is judged to be congested, for example, when an “n” number of web servers are constructed for the host name of a web server, the IP address of the web server which has been judged to be congested will be returned once for every “n” number of address solution requests to the DNS server for client access. In other words, during the congestion period of the web server having the corresponding IP address, user service efficiency will decrease since a restriction message will be returned once for every “n” number of requests for the host name.

Also, to realize the method that uses monitoring constantly or periodically at the client or DNS server site the load states of the plural web servers constructed using the DNS round robin, and sequentially returning, as a response to an address solution request, IP addresses lower in load or higher in response time, some type of communication needs to be conducted constantly or periodically in order to check the load states of individual web servers. Additionally in this case, when a large number of web servers are present, there is the problem that the load required for load state management of each web server will increase or that network congestion will occur during load-checking communication.

The present invention was made in order to solve the above problems, and an object of the invention is to provide a congestion controller capable of improving total throughput for improved service reliability by avoiding congestion in web servers assigned to a plurality of IP addresses.

Another object of the present invention is to provide a congestion controller that can independently improve user service efficiency without modification of a conventional DNS server, a client, or a web server, and thus reduce introduction costs.

In order to solve the above problems, a congestion controller according to the present invention has the following construction. That is, when the congestion controller relays a request message addressed from a client to a web server, the controller acquires an IP address of the destination web server via a DNS server, stores into a memory an association between a host name of the destination web server and the acquired IP address, acquires another IP address from a host name of a web server to which another request message from the client is addressed, via the DNS server, and searches for yet another IP address if a web server of that second IP address is judged to be congested. If the web server of the second IP address which has been searched for is judged not to be congested, the controller transfers the request message to this web server judged not to be congested.

Thus, a request message addressed only to the web server of the IP address which has been judged to be congested, among all web servers of the IP addresses constructed using the DNS round robin, can be forwarded to a non-congested web server of another IP address to reduce the congestion messages returned to the client, and hence to improve service efficiency for the client.

When the DNS server supports a DNS reverse lookup function, it is also possible, by using the DNS reverse lookup function, to confirm whether another retrieved IP address is currently effective on an associated network, because this method enables association with a configuration change of the network at the web server side.

In addition, when the web server of an IP address is in a congested state, it is possible, by making a re-inquiry to a web server associated with the DNS server, to confirm whether another IP address of this web server is currently effective on the network. This method also enables association with a network configuration change at the web server side. At the same time, the maximum number of re-inquiries to be conducted may be defined.

In the congestion controller of the present invention, as described above, the request message addressed only to the web server of the IP address which has been judged to be congested, among all web servers of the IP addresses constructed using the DNS round robin, can be forwarded to a non-congested web server of another IP address to reduce the congestion messages returned to the client, and hence to improve service efficiency for the client. At the same time, effectiveness of another IP address to which a request message is to be forwarded can be confirmed and service reliability can thus be improved.

Furthermore, client service efficiency can be improved merely by using this congestion controller, without modifying a conventional DNS server, a client, or a web server, and introduction costs can therefore be reduced.

According to the present invention, it is possible to provide a congestion controller capable of improving total throughput for improved service reliability by avoiding congestion in web servers assigned to a plurality of IP addresses.

According to the present invention, it is also possible to provide a congestion controller that can independently improve user service efficiency without modification of a conventional DNS server, a client, or a web server, and thus reduce introduction costs.

### BRIEF DESCRIPTION OF THE DRAWINGS

FIG. 1 is a block diagram showing a network configuration which uses a congestion controller according to an embodiment of the present invention;

FIG. 2 is a block diagram showing a hardware configuration of the congestion controller according to the embodiment;

FIG. 3 is a diagram showing an example of an IP address management table 201;

FIG. 4 is a diagram showing an example of a congestion management table 301;

FIG. 5 is a flowchart showing a first example of processing within congestion controller 103 according to the embodiment;

FIG. 6 is a flowchart showing a second example of processing within the congestion controller 103 according to the embodiment;

FIG. 7 is a flowchart showing a third example of processing within the congestion controller 103 according to the embodiment; and

FIG. 8 is a flowchart showing a fourth example of processing within the congestion controller 103 according to the embodiment.

### DETAILED DESCRIPTION OF THE PREFERRED EMBODIMENTS

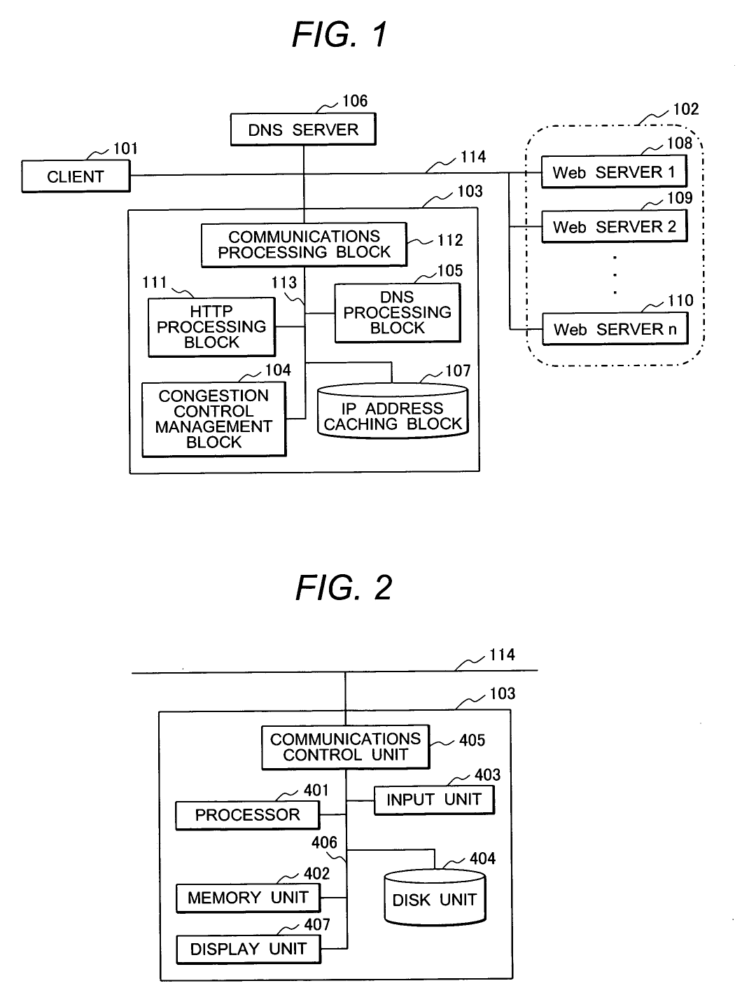

Embodiments of the present invention will be described hereunder with reference to FIGS. 1 to 8.

In each embodiment described below, a DNS server of a DNS (Domain Name Service) system which is one of the most successful name-solving databases on the Internet is used as an element for acquiring an IP address of a destination web server. The kind of element for acquiring IP addresses, however, is not limited to the DNS server.

(Configuration of Congestion Controller)

First, a configurational description of a congestion controller according to an embodiment of the present invention will be given using FIGS. 1 and 2.

FIG. 1 is a block diagram showing a network configuration which uses the congestion controller according to the embodiment.

FIG. 2 is a block diagram showing a hardware configuration of the congestion controller according to the embodiment.

A functional configuration of the congestion controller according to the embodiment, and the network configuration using the congestion controller are described below using FIG. 1.

As shown in FIG. 1, congestion controller 103 of the present embodiment includes a web server 102, a communications processing block 112, an HTTP processing block 111, a DNS processing block 105, an IP address caching block 107, a congestion control management block 104, and an internal communications path 113.

The communications processing block 112 communicates with a client 101, the web server 102, and a DNS server 106, via an external communications line 114, and exchanges IP packets with the former three elements. The HTTP processing block 111 operates as an HTTP (HyperText Transfer Protocol) relay between the client 101 and the web server 102, and conducts HTTP-related processing. The DNS processing block 105 conducts DNS-related processing. The IP address caching block 107 retains as a cache, an association between an IP address which has been solved by the DNS server, and a host name. The congestion control management block 104 retains and manages congestion states of associated web servers for each IP address. The internal communications path 113 is a communications bus that connects each block.

The web server 102 is constructed of a web server 1 (108), a web server 2 (109), and so on up to a web server “n” (110) these web servers being assigned to a plurality of IP addresses registered in the DNS server 106.

When a request message for web page acquisition or the like is sent from the client 101 to the web server 102, the congestion controller 103 first receives the IP packet included in the request message. Next, the controller 103 makes an inquiry to the DNS server 106, calls for an IP address from a host name, and transfers the request message only to the web server associated with the IP address, among all web servers from 1 (108), 2 (109), and so on up to “n” (110).

As shown in FIG. 2, the hardware configuration of the congestion controller 103 according to the present embodiment includes a processor 401, a memory unit 402, an input unit 403, a disk unit 404, a communications control unit 405, an internal communications line 406, and a display unit 407.

The processor 401 executes a program that has been loaded into the memory unit 402, gives operating instructions on input/output units, and controls the entire controller. The memory unit 402 reads in and temporarily retains processing execution programs and data, and stores tables such as the IP address management table 201 and congestion management table 301 described later herein. These tables are stored for read/write operations during program execution. The input unit 403 is hardware used to input the instructions and information relating to congestion control setup and others. A keyboard, a mouse, and other devices are included in the input unit 403. The disk unit 404 is hardware that stores the programs executed by the congestion controller 103, the tables such as the IP address management table 201 and the congestion management table 301, and other necessary data. The disk unit 404 usually has a larger capacity than the memory unit 402. The communications control unit 405 controls the data exchanges conducted between the inside of the congestion controller 103 and outside via the external communications line 114. The internal communications line 406 carries the data exchanged between internal constituent elements of the congestion controller 103. The display unit 407 is hardware by which input information, program execution states, management information, and other various data are displayed for confirmation.

(Data Structure of the Congestion Controller)

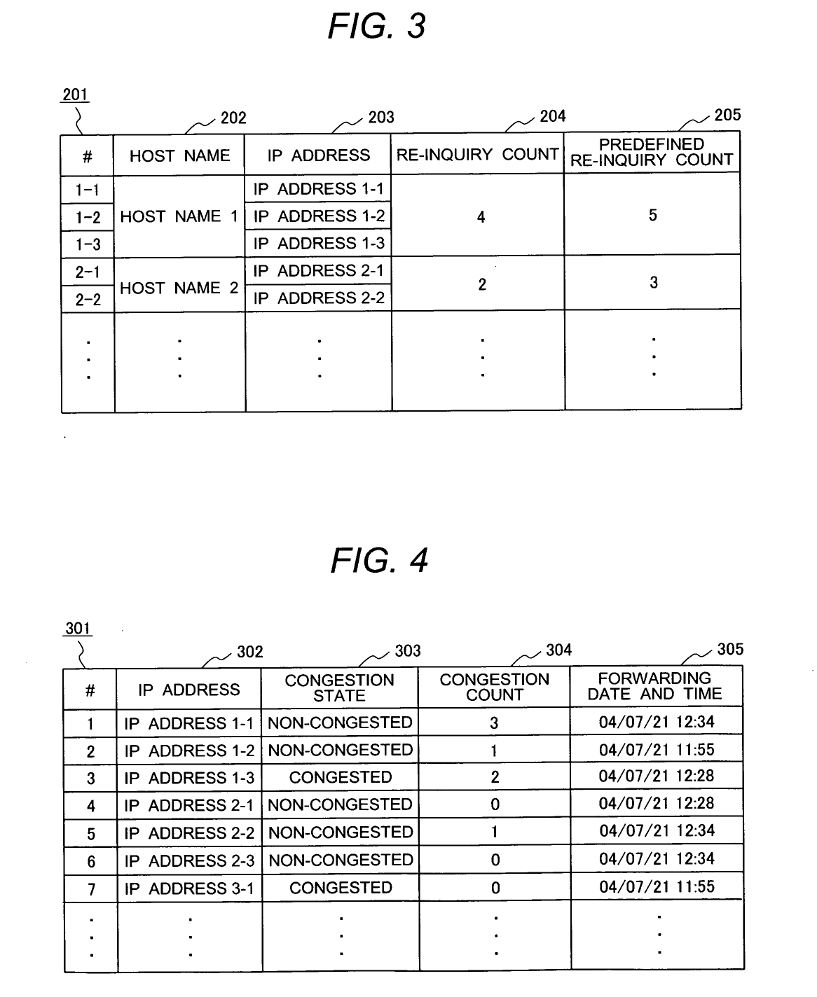

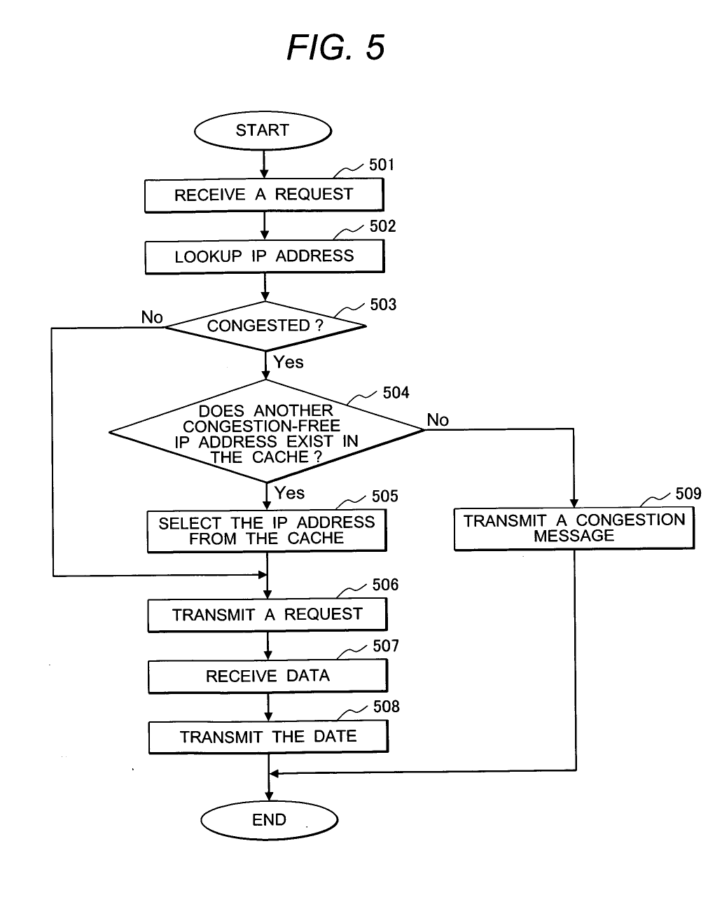

Next, the data structure used in the congestion controller of the present invention is described below using FIGS. 3 and 4.

FIG. 3 is a diagram showing an example of the IP address management table 201.

FIG. 4 is a diagram showing an example of the congestion management table 301.

The IP address management table 201 retains a host name and IP addresses associated therewith, and as shown in FIG. 3, a plurality of IP addresses 203 are associated with one host name 202. In this example, although an entry in the IP address management table 201 may have one IP address 203 assigned to one host name 202, the present invention is particularly advantageous when two or more IP addresses 203 are assigned to one host name 202 as shown in FIG. 3. One server is assigned to one IP address 203. When two or more IP addresses 203 are assigned to one host name 202, therefore, two or more servers are assigned to one host name 202.

A re-inquiry count 204 is a count of actual re-inquiries which were conducted on the DNS server 106 in the fourth example of congestion control processing, described later herein. A predefined re-inquiry count 205 is a value that provides for a maximum allowable number of re-inquiries, and the number of re-inquiries is limited so as not to exceed this value.

The congestion management table 301 is used to manage congestion states of web servers. In this table, as shown in FIG. 4, a congestion state 303 of a web server assigned to an IP address 302 is defined and a count 304, namely, how often congestion was judged to have occurred for the IP address, and the latest date/time 305 when a request was forwarded thereto are retained as congestion management information. The congestion management table 301 is retained and referred to by the congestion control management block 104 shown in FIG. 1.

(First Example of Congestion Control Processing)

A first example of processing by the congestion controller 103 according to the present embodiment is described below using FIG. 5. FIG. 5 is a flowchart showing the first example of processing by congestion controller 103 according to the embodiment.

In the description of processing, reference is made to FIGS. 1 to 4 as appropriate.

First, in step 501, the congestion controller 103 shown in FIG. 1 receives a request message (hereinafter, also referred to simply as the request) from the client 101 via the communications processing block 112. The request usually includes a host name to specify a web server. In step 502, the congestion controller 103, after receiving the request, controls the HTTP processing block 111 to analyze the request and then controls the DNS processing block 105 to make an inquiry for lookup to the DNS server 106 via the communications processing block 112 in order to solve an IP address of a host name of that destination web server.

In step 503, after receiving a solved IP address, the congestion controller 103 caches the IP address into the IP address caching block 107 via the communications processing block 112 and judges whether a web server 102 associated with the IP address is congested. This judgment conducted in the congestion control management block 104 uses a congestion state 303 associated with the IP address 302 in the congestion management table 301 of FIG. 4.

If the web server 102 associated with the IP address is not congested, the congestion controller 103 controls the HTTP processing block 111 to transfer the request to the web server 102 of that IP address via the communications processing block 112 in step 506, then receive data from the web server 102 in step 507, and transfer the data to the client 101 in step 508.

If, in step 503, the web server 102 of the IP address is judged to be congested, the congestion controller 103 proceeds to step 504 to view the IP address caching block 107 and the IP address management table 201 of FIG. 3 and check for cached server names of non-congested servers assigned to IP addresses 203 different from the above IP address and associated with the host name 202 thereof. If a server name of any one of the non-congested servers assigned to the different IP addresses 203 is judged not to have been cached, the web server 102 for the destination host name is judged to be congested. In step 509, therefore, a congestion message for restriction is created in the HTTP processing block 111 and transmitted to the client 101 via the communications processing block 112.

Conversely, if, in step 504, the server name of any one of the non-congested servers assigned to the different IP addresses 203 is judged to have been cached, one of these IP addresses is selected in step 505 and then the HTTP processing block 111 is controlled to transfer the request to the web server 102 of the selected IP address via the communications processing block 112 in step 506. Next after data has been received from the web server 102 in step 507, the data is transmitted to the client 101 in step 508.

In step 505, if two or more server names of the non-congested servers assigned to the different IP addresses are judged to have cached, IP addresses are desirably selected in predetermined order. For example, an IP address associated with the smallest congestion count 304 shown in FIG. 4 may be selected first or an IP address associated with the latest forwarding date/time 305 may be selected first.

(Second Example of Congestion Control Processing)

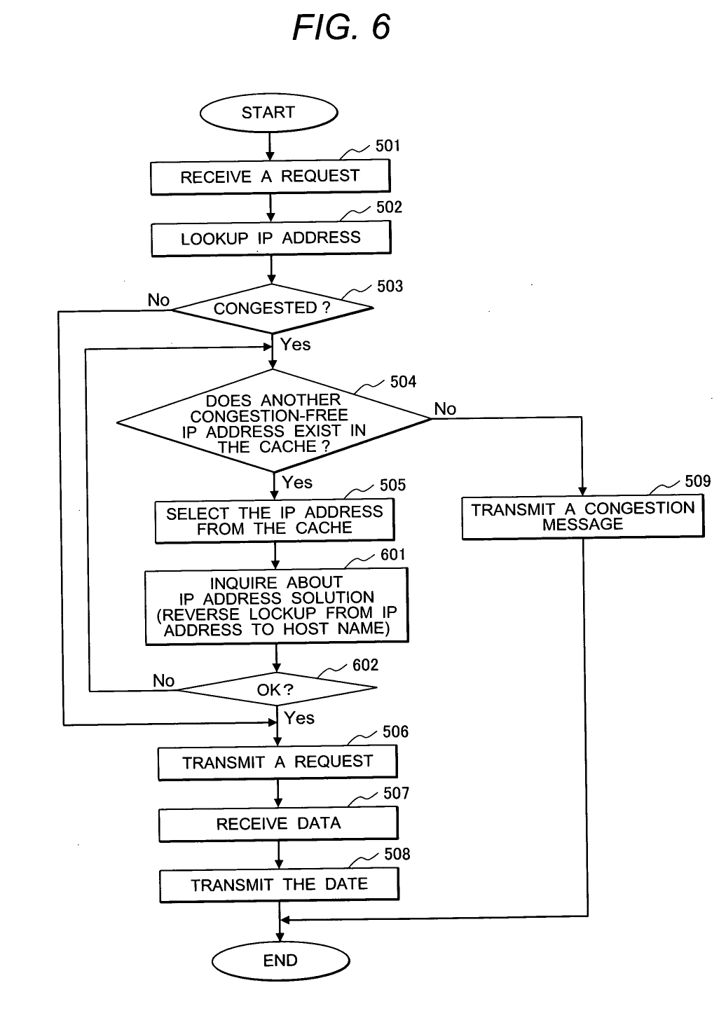

A second example of processing by the congestion controller 103 according to the present embodiment is described below using FIG. 6.

FIG. 6 is a flowchart showing the second example of processing by congestion controller 103 according to the embodiment.

The second example of processing assumes that the congestion controller 103 has exactly the same configuration as that described in the first example of processing. The second example of processing also assumes a form in which a reverse lookup inquiry is made to the DNS server 106 to confirm effectiveness of the IP address selected in step 505. Of course, the confirmation presupposes that the DNS server 106 has a DNS reverse lookup function to call for a host name from an IP address.

The effectiveness of the IP address is thus confirmed with the DNS server 106 to provide against possible changes in IP address assignments due to configurational changes at the web server side.

First, as shown in FIG. 6, the congestion controller 103 receives a request from the client 101 via the communications processing block 112 in step 501. In step 502, the congestion controller 103 controls the HTTP processing block 111 to analyze the request and then controls the DNS processing block 105 to make an inquiry for lookup to the DNS server 106 via the communications processing block 112 in order to solve an IP address of a host name assigned to a web server to which the request is addressed.

In step 503, after receiving a solved IP address, the congestion controller 103 caches the IP address into the IP address caching block 107 via the communications processing block 112 and judges whether a web server associated with the IP address is congested. During this judgment conducted in the congestion control management block 104, reference is made to the congestion state 303 associated with the IP address 302 in the congestion management table 301 of FIG. 4.

If the web server associated with the IP address is not congested, the congestion controller 103 controls the HTTP processing block 111 to transfer the request to the web server 102 of that IP address via the communications processing block 112 in step 506, then receive data from the web server 102 in step 507, and transfer the data to the client 101 in step 508.

If, in step 503, the web server 102 of the IP address is judged to be congested, the congestion controller 103 proceeds to step 504 to view the IP address caching block 107 and the IP address management table 201 of FIG. 3 and check for cached server names of non-congested servers assigned to IP addresses 203 different from the above IP address 203 and associated with the host name 202 thereof. If a server name of either of the non-congested servers assigned to the different IP addresses is judged not to have been cached, the web server 102 for the destination host name is judged to be congested. In step 509, therefore, a congestion message for restriction is created in the HTTP processing block 111 and transmitted to the client 101 via the communications processing block 112.

Conversely, if, in step 504, the server name of any one of the non-congested servers assigned to the different IP addresses 203 is judged to have been cached, one of these IP addresses is selected in step 505.

In step 505, if two or more server names of the non-congested servers assigned to the different IP addresses are judged to have cached, IP addresses are desirably selected in predetermined order. For example, an IP address associated with the smallest congestion count 304 shown in FIG. 4 may be selected first or an IP address associated with the latest forwarding date/time 305 may be selected first.

Next, the congestion controller 103 controls the DNS processing block 105 in step 601 so that an inquiry for reverse lookup of the IP address which was selected in step 505 is made to the DNS server 106 via the communications processing block 112. After executing step 602 to judge whether the inquiry has been successful, the congestion controller 103 controls the HTTP processing block 111 to transfer the request to the web server 102 of the selected IP address via the communications processing block 112 in step 506. Next after data has been received from the web server 102 in step 507, the data is transmitted to the client 101 in step 508.

If the inquiry for reverse lookup of the selected IP address failed in step 602, the failure means that the selected IP address is not effective. That is, the failure means that a configurational change has been conducted at the web server side and thus that an assigned IP address has been changed to become unusable. In this case, the congestion controller 103 returns to step 504 to recheck for cached server names of non-congested servers assigned to different IP addresses 203. Subsequently, steps 504 to 602 are likewise repeated.

(Third Example of Congestion Control Processing)

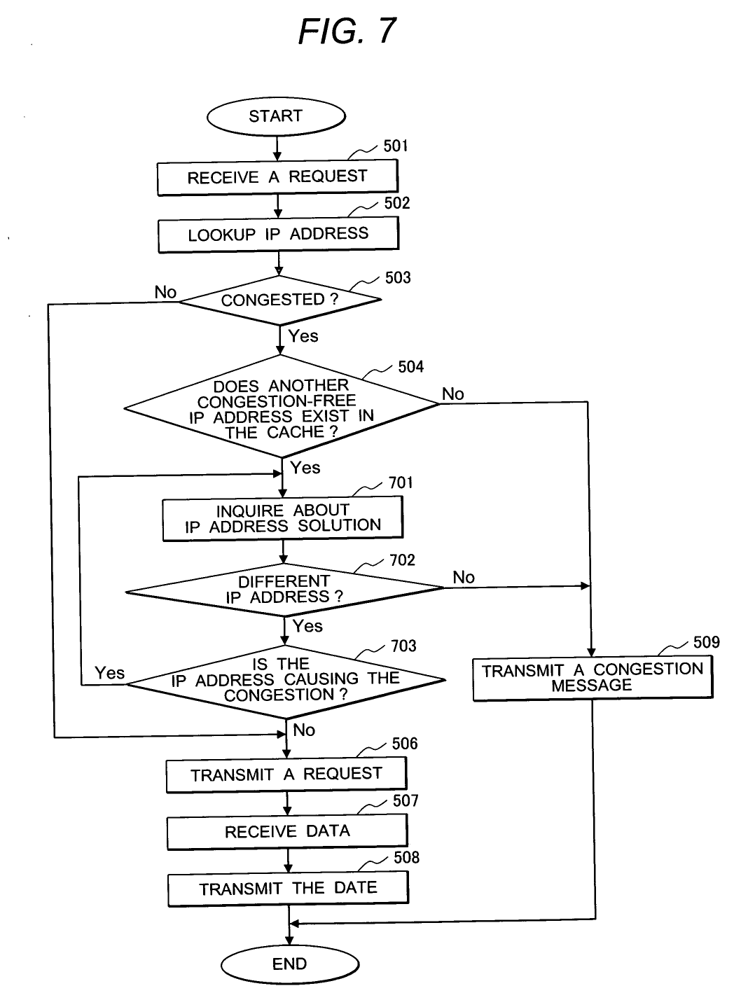

A third example of processing by the congestion controller 103 according to the present embodiment is described below using FIG. 7.

FIG. 7 is a flowchart showing the third example of processing by congestion controller 103 according to the embodiment.

The third example of processing assumes that the congestion controller 103 has exactly the same configuration as that described in the first example of processing. However, processing in the third example takes a form in which, when the DNS server 106 does not always support a reverse lookup inquiry, in step 505 of the first example of processing, instead of selecting an different IP address, the congestion controller 103 confirms the effectiveness of a different IP address by conducting an IP address resolution once again for the DNS server 106 and judging whether a solved IP address matches a cached IP address.

This processing form is intended mainly to absorb any changes in the web server configuration similarly to the second example of processing.

First, as shown in FIG. 7, the congestion controller 103 receives a request from the client 101 via the communications processing block 112 in step 501. In step 502, the congestion controller 103 controls the HTTP processing block 111 to analyze the request and then controls the DNS processing block 105 to make an inquiry for lookup to the DNS server 106 via the communications processing block 112 in order to solve an IP address of a host name assigned to a web server to which the request is addressed.

In step 503, after receiving a solved IP address, the congestion controller 103 caches the IP address into the IP address caching block 107 via the communications processing block 107 and judges whether a web server associated with the IP address is congested. During this judgment conducted in the congestion control management block 104, reference is made to the congestion state 303 associated with the IP address 302 in the congestion management table 301 of FIG. 4. If the web server associated with the IP address is not congested, the congestion controller 103 controls the HTTP processing block 111 to transfer the request to the web server 102 of that IP address via the communications processing block 112 in step 506, then receive data from the web server 102 in step 507, and transfer the data to the client 101 in step 508.

If, in step 503, the web server 102 of the IP address is judged to be congested, the congestion controller 103 proceeds to step 504 to view the IP address caching block 107 and the IP address management table 201 of FIG. 3 and check for cached server names of non-congested servers assigned to IP addresses 203 different from the above IP address 203 and associated with the host name 202 thereof. If a server name of either of the non-congested servers assigned to the different IP addresses 203 is judged not to have been cached, the web server 102 for the destination host name is judged to be congested. In step 509, therefore, a congestion message for restriction is created in the HTTP processing block 111 and transmitted to the client 101 via the communications processing block 112.

Conversely, in step 504, the server name of any one of the non-congested servers assigned to the different IP addresses 203 may be judged to have been cached. In such a case, in step 701, the congestion controller 103 controls the DNS processing block 105 once again to make an inquiry to the DNS server 106 via the communications processing block 112 in order to solve an IP address of a host name assigned to the web server to which the request is addressed. In step 702, after receiving a solved IP address, the congestion controller 103 caches the IP address into the IP address caching block 107 via the communications processing block 112 and judges whether the IP address is the same as that which was solved in step 502 as a result of the first inquiry. If both IP addresses are judged to be the same, the web server 102 for the destination host name is judged to be congested. In step 509, therefore, a congestion message for restriction is created in the HTTP processing block 111 and transmitted to the client 101 via the communications processing block 112.

If, in step 702, the two IP addresses are judged to be different from each other, the congestion controller 103 controls the congestion control management block 104 in step 703 to judge whether a web server associated with the IP address which was solved as a result of the re-inquiry is congested. If this web server is congested, the congestion controller 103 returns to step 701 to make a further inquiry to the DNS server 106 in order to solve an IP address of a host name assigned to the web server to which the request is addressed. Subsequently, steps 701 to 703 are likewise repeated.

If, in step 703, the web server associated with the IP address which was solved as a result of the further inquiry is judged not to be congested, the congestion controller 103 controls the HTTP processing block 111 to transfer the request to the web server 102 of the solved IP address via the communications processing block 112 in step 506. Next after data has been received from the web server 102 in step 507, the data is transmitted to the client 101 in step 508.

(Fourth Example of Congestion Control Processing)

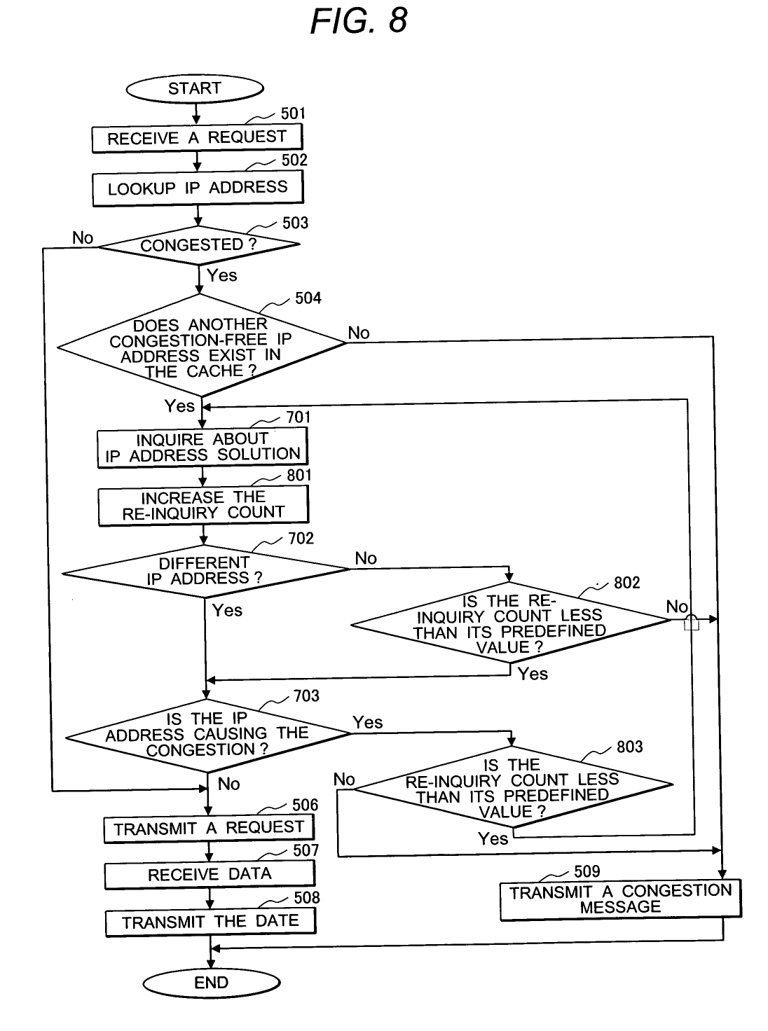

A fourth example of processing by the congestion controller 103 according to the present embodiment is described below using FIG. 8. FIG. 8 is a flowchart showing the fourth example of processing by congestion controller 103 according to the embodiment.

The fourth example of processing assumes that the congestion controller 103 has exactly the same configuration as that described in the third example of processing. However, processing in the third example takes a form in which, if the IP address that was solved as the result of the further inquiry in step 702 is the same as the IP address solved as the result of the first inquiry, the congestion controller 103 does not transmit a congestion message immediately after conducting a congestion judgment. Instead, the congestion controller 103 repeats a similar inquiry up to a fixed count of re-inquiries. In addition, the number of re-inquiries to be repeated is limited to a fixed value if, in step 703, a web server associated with the IP address that was solved as a result of a re-inquiry is judged to be congested.

First, after receiving a request from the client 101 via the communications processing block 112 in step 501, the congestion controller 103 conducts control in step 502 to ensure that the HTTP processing block 111 analyzes the request and that the DNS processing block 105 makes an inquiry for lookup to the DNS server 106 via the communications processing block 112 to solve an IP address of a host name assigned to a web server to which the request is addressed.

In step 503, after receiving a solved IP address, the congestion controller 103 caches the IP address into the IP address caching block 107 via the communications processing block 107 and judges whether a web server associated with the IP address is congested. During this judgment conducted in the congestion control management block 104, reference is made to the congestion state 303 associated with the IP address 302 in the congestion management table 301 of FIG. 4. If the web server associated with the IP address is not congested, the congestion controller 103 controls the HTTP processing block 111 to transfer the request to the web server 102 of that IP address via the communications processing block 112 in step 506, then receive data from the web server 102 in step 507, and transfer the data to the client 101 in step 508.

If, in step 503, the web server 102 of the IP address is judged to be congested, the congestion controller 103 proceeds to step 504 to view the IP address caching block 107 and the IP address management table 201 of FIG. 3 and check for cached server names of non-congested servers assigned to IP addresses 203 different from the above IP address 203 and associated with the host name 202 thereof. If a server name of either of the non-congested servers assigned to the different IP addresses 203 is judged not to have been cached, the web server 102 for the destination host name is judged to be congested. In step 509, therefore, a congestion message for restriction is created in the HTTP processing block 111 and transmitted to the client 101 via the communications processing block 112.

In step 504, the server name of any one of the non-congested servers assigned to the different IP addresses 203 may be judged to have been cached. In such a case, in step 701, the congestion controller 103 controls the DNS processing block 105 once again to make an inquiry to the DNS server 106 via the communications processing block 112 in order to solve an IP address of a host name assigned to the web server to which the request is addressed. The re-inquiry count 204 for a destination host name, shown in FIG. 3, is thus increased in step 801. In step 702, after receiving a solved IP address, the congestion controller 103 caches the IP address into the IP address caching block 107 via the communications processing block 112 and judges whether the IP address is the same as that which was solved in step 502 as a result of the first inquiry. If both IP addresses are judged to be the same, the re-inquiry count 204 shown in FIG. 3 is examined in step 802 to see whether a predefined re-inquiry count 205 is reached. If the predefined re-inquiry count 205 is reached, the web server 102 for the destination host name is regarded as congested. In step 509, therefore, a congestion message for restriction is created in the HTTP processing block 111 and transmitted to the client 101 via the communications processing block 112.

If, in step 802, the re-inquiry count 204 is less than the predefined count 205, or, in step 702, the two IP addresses are judged to be different from each other, the congestion controller 103 controls the congestion control management block 104 in step 703 to judge whether a web server associated with the IP address which was solved as a result of the re-inquiry is congested. If this web server is congested, the congestion controller 103 once again examines the re-inquiry count 204 of FIG. 3 in step 803 to see whether the predefined re-inquiry count 205 is reached. If the predefined re-inquiry count 205 is reached, the web server 102 for the destination host name is regarded as congested. In step 509, therefore, a congestion message for restriction is created in the HTTP processing block 111 and transmitted to the client 101 via the communications processing block 112.

If the re-inquiry count 204 is less than the predefined count 205 in step 803, the congestion controller 103 returns to step 701 to make a further inquiry to the DNS server 106 in order to solve an IP address of a host name assigned to the web server to which the request is addressed. Subsequently, steps 701 to 703 are likewise repeated.

If, in step 703, the web server associated with the IP address which was solved as a result of the further inquiry is judged not to be congested, the congestion controller 103 controls the HTTP processing block 111 to transfer the request to the web server 102 of the solved IP address via the communications processing block 112 in step 506. Next after data has been received from the web server 102 in step 507, the data is transmitted to the client 101 in step 508.

1. A congestion controller that receives a request message transmitted from a client to a server via a network and then responds to the client with a congestion message instead of transferring the request message to the server, the controller comprising:
means for acquiring an IP address of the server from a host name included in the request message; and
means for retaining information on an association between an acquired host name of the server and the IP address thereof;
wherein the controller acquires the IP address of the server from the host name included in the request message, then after checking the information on the association between the acquired host name of the server and the IP address thereof, seeks for the server associated with the IP address, and judges whether the server is congested; and wherein, if the server is congested, there exists a second IP address associated with the host name of the server which has been judged to be congested, and the controller transfers the request message received from the client, to a second server to which the second IP address is assigned.

2. The congestion controller according to claim 1, further comprising, on the network, a DNS (Domain Name System) server with a DNS reverse lookup function, wherein:
there exists a second IP address associated with the host name of the server which has been judged to be congested, and if a second server to which the second IP address is assigned is not congested, the controller checks for effectiveness of the second IP address by using the DNS reverse lookup function of the DNS server, and if the second IP address is judged to be effective, transfers the request message received from the client, to the second server to which the second IP address is assigned.

3. The congestion controller according to claim 1, further comprising a DNS server on the network, wherein:
there exists a second IP address associated with the host name of the server which has been judged to be congested; and
if a second server to which the second IP address is assigned is not congested, the controller makes an IP address inquiry with a host name of the second server to the DNS server, then checks for effectiveness of the second IP address, and if the second IP address is judged to be effective, transfers the request message received from the client, to the second server to which the second IP address is assigned.

4. A congestion controller that receives, via an IP packet transmitting/receiving network, a request message transmitted from a client to a web server, then after seeking for the destination web server via a DNS server, transfers the request message to the web server, and if the web server is congested, responds to the client with a congestion message instead of transferring the request message to the web server, the controller comprising:
a communications processor that processes transmission/reception of packets present on the network;
an HTTP processor that controls a protocol of communication with the web server;
a DNS processor that controls a protocol of communication with the DNS server;
an IP address caching section that retains information on an association between host names and IP addresses; and
a congestion control manager that retains congestion state information on web servers assigned for each of the IP addresses;
wherein:
the DNS processor makes an inquiry to the DNS server and obtains an IP address associated with a host name included in the request message;
the IP address caching section records the association between the host name and the IP address; and
in accordance with the congestion state information retained in the congestion control manager and with the association between the host name and the IP address recorded in the IP address caching section, if the web server assigned to the IP address to which the request message is to be transferred is judged to be congested, the HTTP processor seeks for a second IP address associated with the host name of the web server which has been judged to be congested, and when the web server to which the second IP address is assigned is not congested, transfers the request message received from the client, to the web server having the assigned second IP address; and
wherein, when the web server having the IP address to which the request message is to be sent is not congested, the HTTP processor transfers the request message to the web server.

5. A method for controlling congestion of a network, in which method, a request message transmitted from a client to a server via a network is received and when the server is congested, a congestion message is sent to the client as a response instead of the request message being transferred to the server, the control method comprising the steps of:
acquiring an IP address of the server from the information contained in the request message; and
recording information on an association between an acquired host name of the server and the IP address thereof;
acquiring the IP address of the server from the information contained in the request message, and seeking for the server associated with the IP address from the information on the association between the acquired host name of the server and the IP address thereof;
judging whether the server is congested, and if the server is congested, searching for a second IP address associated with the host name of the server which has been judged to be congested, the second IP address being assigned to a non-congested server;
transferring the request message received from the client, to the server to which the second IP address that has been searched for is assigned; and
if the server is not congested, transferring the request message to a server having a host name associated with the IP address.

6. The method for controlling congestion of a network according to claim 5, on which network is disposed a DNS server with a DNS reverse lookup function, the method further comprising the step of:
confirming effectiveness of the second IP address by using the DNS reverse lookup function of the DNS server;
wherein the request message from the client is transferred to a server to which is assigned the second IP address whose effectiveness has been judged.

7. The method for controlling congestion of a network according to claim 5, on which network is disposed a DNS server, the method further comprising the steps of:
confirming effectiveness of the second IP address by making an IP address inquiry with a host name of the server to the DNS server; and
transferring the request message of the client to a server to which is assigned the second IP address whose effectiveness has been judged.

8. The method for controlling congestion of a network according to claim 7, wherein both a congestion state for each IP address and a maximum allowable number of inquiries to the DNS server are retained and each inquiry is made thereto within a range that does not exceed the maximum allowable number of inquiries.
